(19) United States
(12) Patent Application Publication
(10) Pub. No.: US 2015/0051819 A1
(43) Pub. Date: Feb. 19, 2015

(54) SYSTEMS AND METHODS FOR CONTROLLING SOUND GENERATED BY A VEHICLE DURING VEHICLE START-UP OPERATIONS

(71) Applicants: Nathaniel Ellis, Marysville, OH (US); Nicholas A. Scheufler, Dublin, OH (US)

(72) Inventors: Nathaniel Ellis, Marysville, OH (US); Nicholas A. Scheufler, Dublin, OH (US)

(73) Assignee: Honda Motor Co., Ltd., Tokyo (JP)

(21) Appl. No.: 13/966,573

(22) Filed: Aug. 14, 2013

(51) Int. Cl. F02D 28/00

(52) U.S. Cl. CPC F02D 28/00
USPC 701/113

(57) ABSTRACT

A method for controlling start-up operations of a vehicle is provided. The method includes receiving user settings indicative of at least a desired time during which sound generated during start-up operations is controlled. The method also includes determining current environmental conditions indicative of at least one of a current time of day and a current geographical location of the vehicle, and comparing the current environmental conditions with the user settings. The method also includes controlling the sound generated by the vehicle during vehicle start-up operations based at least in part on a result of the comparison between the current environmental conditions and the user settings.

### BACKGROUND

The present disclosure relates generally to vehicle operations, and more specifically to systems for use in controlling sound generated by a vehicle during start-up conditions.

Some current vehicles generate a loud and distinctive sound during start-up. The distinctive start-up sound may be a desirable feature of the vehicle. For example, at least some known sports and luxury vehicles generate a noticeable and distinct sound when starting so as to distinguish that vehicle from other vehicles.

Although a distinctive start-up sound may be desirable in many instances, such as during the middle of the day, the noise associated with the same sound may be problematic at other times, such as late in the evening, early in the morning, and/or when the vehicle is in a quiet neighborhood. At least some known starting systems enable a user to selectively reduce the start-up sound through use of a switch or through after-market additions. However, known starting systems may be cumbersome to install and require the user to remember to manually turn on or off the start-up sound before starting the vehicle.

### BRIEF DESCRIPTION

In one aspect, a method for controlling start-up operations of a vehicle is provided. The method includes receiving user settings indicative of at least a desired time during which sound generated during start-up operations is controlled. The method also includes determining current environmental conditions indicative of at least one of a current time of day and a current geographical location of the vehicle, and comparing the current environmental conditions with the user settings. The method also includes controlling the sound generated by the vehicle during vehicle start-up operations based at least in part on a result of the comparison between the current environmental conditions and the user settings.

In another aspect, a start-up control system for use in a vehicle is provided. The start-up control system includes a start-up controller configured to receive user settings indicative of at least a desired time during which sound generated by the vehicle during start-up operations is controlled, and determine current environmental conditions indicative of at least one of a current time of day and a current geographical location of the vehicle. The start-up controller is also configured to compare the current environmental conditions with the user settings, and control the sound generated by the vehicle during start-up operations based at least in part on a result of the comparison between the current environmental conditions and the user settings.

In yet another aspect, one or more computer readable storage media having computer executable instructions embodied thereon is provided. When executed by at least one processor, the computer-executable instructions cause the processor to receive user settings indicative of at least a desired time during which sound generated by a vehicle during start-up operations is controlled, and determine current environmental conditions indicative of at least one of a current time of day and a current geographical location of the vehicle. The computer-executable instructions also cause the processor to compare the current environmental conditions with the user settings, and control the sound generated by the vehicle during start-up operations based at least in part on a result of the comparison between the current environmental conditions and the user settings.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is an exemplary start-up control system for use with a vehicle.

FIG. 2 is a schematic illustration of an exemplary start-up controller that may be used with the start-up control system described in FIG. 1.

FIG. 3 is a block diagram of an exemplary method that may be performed by the start-up control system shown in FIG. 1.

Although specific features of various implementations may be shown in some drawings and not in others, this is for convenience only. Any feature of any drawing may be referenced and/or claimed in combination with any feature of any other drawing.

### DETAILED DESCRIPTION

The embodiments described herein provide a start-up control system for use with a vehicle. More specifically, the start-up control system includes a start-up controller that receives and stores settings indicative of at least one of a time of day and a geographical area for which the user has decided to control the sound of the vehicle during start-up operations. For example, at least one of a time range and a geographical area may be associated with a quiet start mode while other time ranges may be associated with a normal start mode. When the vehicle receives an ignition request, the start-up controller determines the current status of environmental conditions associated with the vehicle. Environmental conditions, also referred to herein as ambient parameters, are defined as including, without limitation, a current time of day in which the ignition request is received and/or a current geographical location of the vehicle when the ignition request is received. The start-up controller compares the environmental conditions with the stored user settings, and controls the sound generated by the vehicle during vehicle start-up operations based on a result of the comparison between the environmental conditions and the stored user settings.

As used herein, the term “start-up sound” refers to sound produced by a vehicle when the engine is started, i.e., during vehicle start-up operations. The start-up sound may be generated by a volume of exhaust leaving an exhaust system, by the engine operating at a high operating speed, and/or by any other means associated with starting the vehicle. Alternatively, at least a portion of the start-up sound may be artificially generated by an audio system including, for example, an amplifier and/or speaker system. As used herein, the term “normal start mode” refers to a vehicle operating mode during which sound generated during vehicle start-up operations is generated without activation of the sound-reducing measures associated with the start-up control system described herein, i.e., as if the vehicle did not include a start-up control system.

In contrast, as used herein, the term “quiet start mode” refers to a vehicle operating mode during which at least one of the magnitude and duration of sound generated during vehicle start-up operations is reduced as compared to normal start-up operations.

As used herein, an element or step recited in the singular and preceded with the word “a” or “an” should be understood as not excluding plural elements or steps, unless such exclusion is explicitly recited. Furthermore, references to one “implementation” or one “embodiment” of the subject matter described herein are not intended to be interpreted as excluding the existence of additional implementations that also incorporate the recited features. The following detailed description of implementations consistent with the principles of the disclosure refers to the accompanying drawings. In the absence of a contrary representation, the same reference numbers in different drawings may identify the same or similar elements.

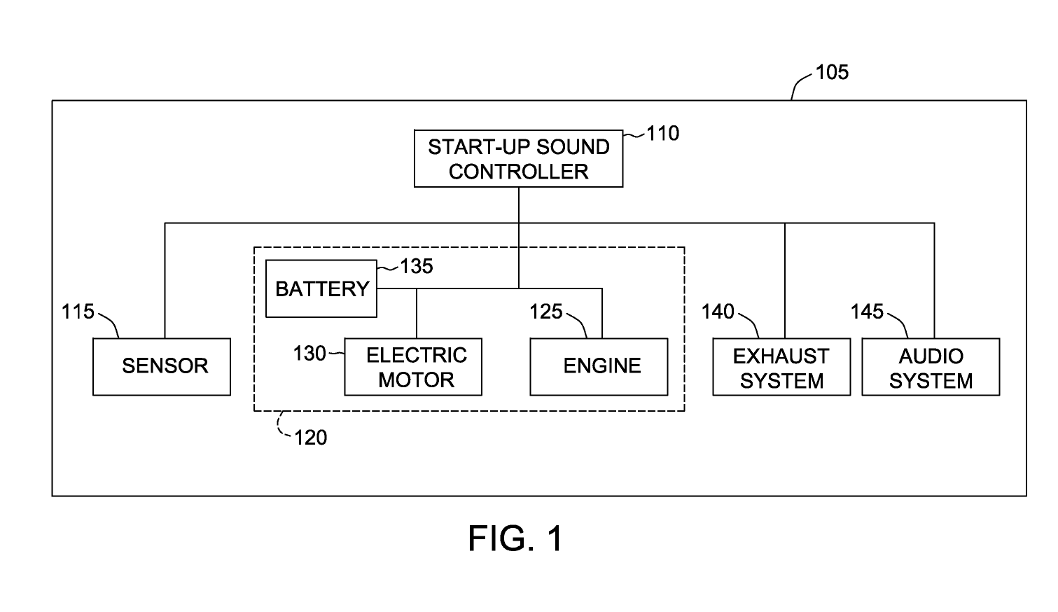

FIG. 1 illustrates an exemplary embodiment of a start-up control system 100 for use with a vehicle 105. Vehicle 105 may be any type of vehicle including, but not limited to, an automobile, a truck, a sedan, a van, and/or a marine vehicle, for example. In the exemplary embodiment, start-up control system 100 is included within vehicle 105 and includes at least a start-up controller 110 that is coupled to a sensor 115. In the exemplary embodiment, start-up controller 110 is also communicatively coupled to at least one of a vehicle propulsion system 120, an exhaust system 140, and an audio system 145.

In one implementation, vehicle propulsion system 120 includes an engine 125, e.g., without limitation an internal combustion engine, that provides a motorized force that selectively propels vehicle 105. In another implementation, vehicle 105 may be a hybrid electric vehicle 105; in such an implementation, vehicle propulsion system 120 includes engine 125, an electric motor 130, and at least one battery 135, or bank of batteries 135, that provide a motorized force that selectively propels vehicle 105. Alternatively, vehicle 105 may be an electric only vehicle or may be powered by any type of power source, e.g., without limitation a hydrogen fuel cell, that enables vehicle 105 to operate as described herein. In the exemplary embodiment, vehicle propulsion system 120 selectively controls the speed at which engine 125 operates. Also in the exemplary embodiment, vehicle propulsion system 120 controls whether engine 125 or electric motor 130 provides the motorized force that propels vehicle 105.

Also in the exemplary embodiment, exhaust system 140 selectively controls the volume and/or angle at which exhaust is discharged by vehicle 105. More specifically, exhaust system 140 may reposition at least one valve (not shown) and/or flap (not shown) to control the volume, duration, and or pitch of sound generated being discharged by vehicle 105 during vehicle start-up operations.

In the exemplary embodiment, audio system 145 selectively transmits sound through at least one speaker and/or amplifier during vehicle start-up operations. More specifically, start-up controller 110 controls the volume, duration, and sound produced by audio system 145 during start-up conditions, including, for example, controlling audio system to not produce sound.

In the exemplary embodiment, start-up controller 110 controls the sound produced by vehicle 105 during start-up operations based on current environmental conditions. More specifically, start-up controller 110 compares environmental conditions measured by sensor 115 with user settings stored in a memory (not shown). Start-up controller 110 controls sound generated by at least one of vehicle propulsion system 120, exhaust system 140, and audio system 145 based on the results of the comparison. In the exemplary embodiment, start-up controller 110 may be associated with a plurality of settings, e.g., without limitation sound to be played, volume, and duration, selectively controlled by a user. The settings may be stored in a memory (not shown in FIG. 1) associated with vehicle 105 and/or the settings may be uploaded from a remote terminal such as a smartphone, laptop, personal computer, PDA, tablet, or any other computing device. For example, the settings may include an audio file uploaded to start-up controller 110 to be played by audio system 145 at start-up.

In the exemplary embodiment, sensor 115 determines environmental conditions associated with the vehicle, and transmits the detected information to start-up controller 110. In at least one implementation, sensor 115 determines at least the current time of day. In another implementation, sensor 115 determines a geographic location of the vehicle. Sensor 115 may determine any other parameter that enables the methods and systems to function as described herein, such as, for example, a relative orientation of the vehicle, i.e., whether the vehicle is parked in a quiet area, and/or ambient conditions surrounding the vehicle. Any number of sensors 115 may be utilized to determine the environmental conditions that enable the systems and methods to function as described herein. In at least one implementation, sensor 115 is formed integrally with start-up controller 110. Alternatively, sensor 115 is coupled remotely from start-up controller 110.

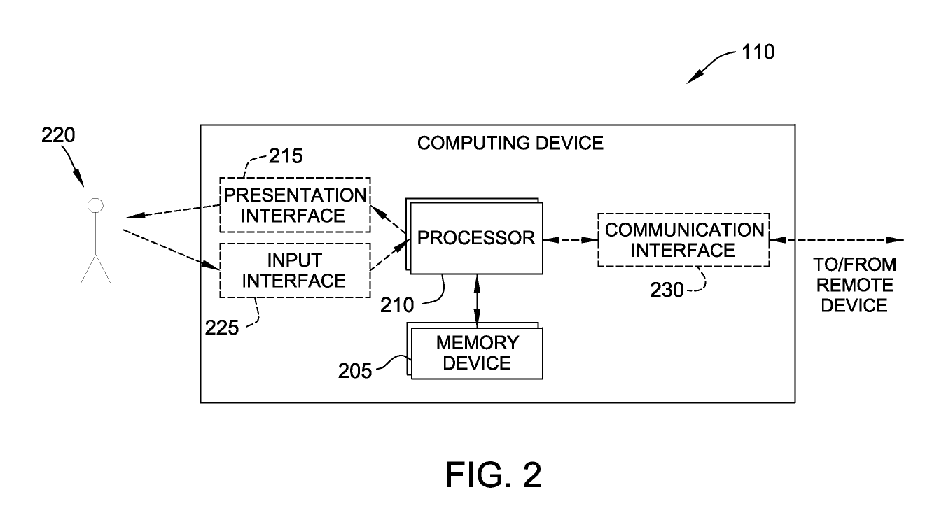

FIG. 2 is a schematic illustration of start-up controller 110. In the exemplary embodiment, start-up controller 110 includes at least one memory device 205, and a processor 210 coupled to memory device 205 for executing instructions. In some implementations, executable instructions are stored in memory device 205. In the exemplary embodiment, start-up controller 110 performs one or more operations described herein by executing instructions stored in memory device 205 with processor 210.

Processor 210 may include one or more processing units (e.g., in a multi-core configuration). Further, processor 210 may be implemented using one or more heterogeneous processor systems in which a main processor is present with secondary processors on a single chip. In another illustrative example, processor 210 may be a symmetric multi-processor system containing multiple processors of the same type. Further, processor 210 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein.

In the exemplary embodiment, memory device 205 is one or more devices that enable information such as executable instructions and/or other data to be stored and retrieved. Memory device 205 may include one or more computer readable media, such as, without limitation, dynamic random access memory (DRAM), static random access memory (SRAM), a solid state disk, and/or a hard disk. Memory device 205 may be configured to store, without limitation, application source code, application object code, source code portions of interest, object code portions of interest, configuration data, execution events, user settings and/or any other type of data.

In the exemplary embodiment, start-up controller 110 includes a presentation interface 215 that is coupled to processor 210. Presentation interface 215 is configured to present information to a user 220. For example, presentation interface 215 may include a display adapter (not shown) that may be coupled to a display device, such as a cathode ray tube (CRT), a liquid crystal display (LCD), an organic LED (OLED) display, and/or an “electronic ink” display. In some implementations, presentation interface 215 includes one or more display devices. In the exemplary embodiment, presentation interface 215 may present information such as a current status of the start-up controller 110, at least one time range during which a quiet start mode will be enabled, a current geographic location of vehicle 105, or any combination thereof.

In the exemplary embodiment, start-up controller 110 includes a user input interface 225 that is coupled to processor 210. User input interface 225 is configured to receive input from user 220. User input interface 225 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of presentation interface 215 and user input interface 225. In the exemplary embodiment, user input interface 225 may be located within vehicle 105, such as in a console (not shown) or any other location through which user 220 may provide input. In another implementation, user input interface 225 may be located on a remote computing device in communication with start-up controller 110. For example, the remote computing device may be a computer, laptop, PDA, smartphone, tablet or any other device that enables the systems and methods to function as described herein, that is configured to receive input from user 220 and communicate the information to start-up controller 110.

Start-up controller 110, in the exemplary embodiment, includes a communication interface 230 coupled to processor 210. Communication interface 230 communicates with one or more devices, such as sensor 115 (shown in FIG. 1), vehicle propulsion system 120 (shown in FIG. 1), and/or sound generation system 140 (shown in FIG. 1). To communicate with remote devices, communication interface 230 may include, for example, a wired network adapter, a wireless network adapter, an antenna, a mobile telecommunications adapter, and/or any other interface that allows start-up controller 110 to communicate with other vehicle components.

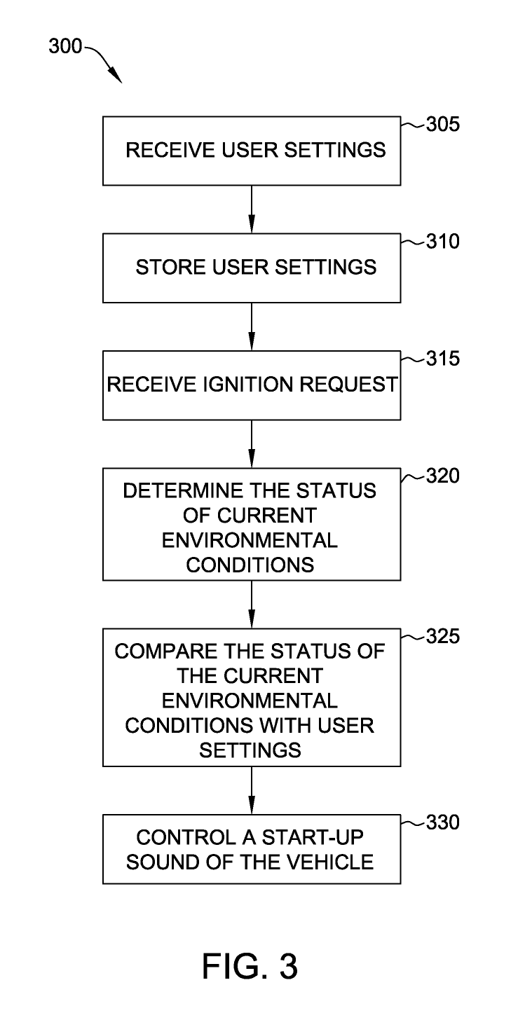

FIG. 3 is a flowchart of an exemplary method 300 that may be implemented by start-up controller 110 (shown in FIGS. 1 and 2), for example to selectively reduce the noise generated by vehicle 105 (shown in FIG. 1) during vehicle start-up operations. In the exemplary embodiment, the sound generated by vehicle 105 during vehicle start-up operations is automatically controlled based at least in part on current environmental conditions.

For example, in one embodiment, start-up controller 110 receives 305 user settings input from user 220 indicating at least one of a desired time range for which the sound generated by vehicle 105 during vehicle start-up operations is controlled. Specifically, start-up controller 110 receives user settings, for example, via input interface 225 (shown in FIG. 2), including at least one time range during which a quiet start mode is enabled for vehicle 105. Alternatively, start-up controller 110 receives user settings including at least one time range during which a normal start mode is enabled.

In another embodiment, start-up controller 110 receives user settings input from user 220 indicating at least one geographic area where the sound generated by vehicle 105 during vehicle start-up operations is controlled. In one implementation, start-up controller 110 receives user settings including at least one geographic location where a quiet start mode is enabled, e.g., without limitation, home, school, or church. Alternatively start-up controller 110 receives user settings including at least one geographic location where a normal start mode is enabled e.g., without limitation, work, restaurants, hotels, or parking lots.

Further, in the exemplary embodiment, user settings may include a plurality of environment conditions associated with the sound generated by vehicle 105 during start-up operations. In one implementation, user settings may include different time ranges to enable a quiet start mode based on different geographical locations associated with vehicle 105. For example, user settings may include a first time range, e.g., 11:00 PM-4:00 AM, to enable a quiet start mode when in a first geographical location, e.g., work, and a second time range, e.g., 9:00 PM-6:00 AM, to enable a quiet start mode when in a second geographical location, e.g., a residential neighborhood.

In the exemplary embodiment, start-up controller 110 is capable of receiving 305 user settings from a plurality of users. For example, in one implementation, start-up controller 110 receives user settings from a second user 220. The second user settings also indicate a second time range during which the sound generated by vehicle 105 during vehicle start-up operations should be controlled. In the exemplary embodiment, start-up controller 110 identifies which of the plurality of user settings to use when starting vehicle 105 by associating each of the plurality of users 220 with a key fob (not shown). Start-up controller 110 identifies the particular key fob associated with the current user 220, and utilizes the corresponding user settings of current user 220. Alternatively, start-up controller 110 may identify the current user 220 through use of, for example, a switch associated with user 220 and manually activated by user 220, or a biometric identifier acquisition system.

Also in the exemplary embodiment, start-up controller 110 stores 310, the user settings in a memory. In some implementations, start-up controller 110 stores 310 the user settings in memory device 205 (shown in FIG. 2) associated with start-up controller 110. In another implementation, start-up controller 110 stores 310 the user settings in a remote memory, such as in a memory located in a key fob associated with user 220. Alternatively, start-up controller 110 stores 310 the user settings in any memory that enables start-up controller 110 to operate as described herein.

In the exemplary embodiment, start-up controller 110 receives 315 an ignition request from user 220 instructing the vehicle to begin operation. Further, in the exemplary embodiment, start-up controller 110 determines 320 the status of environmental conditions associated with controlling the sound generated by vehicle 105 during vehicle start-up operation, including at least one of a current time of day and a current geographical location of vehicle 105.

In the exemplary embodiment, the status of at least one of the current environmental conditions associated with vehicle 105 is compared 325 with the user settings stored in memory device 205 (shown in FIG. 2) by start-up controller 110. In one implementation, the current environmental conditions include the current time of day, and start-up controller 110 compares 325 the current time of day with the at least one time range stored in the memory. In another implementation, the current environmental conditions include a current geographical location, and start-up controller 110 compares 325 the current environmental conditions with at least one geographical area stored in the memory. Alternatively, the current time of day and current geographical location is compared with a time range associated with a geographical area stored in the memory.

In the exemplary embodiment, start-up controller 110 controls 330 sound generated during start-up operations based on the results of the comparison 325 between the user settings and the status of the current environmental conditions. In the exemplary embodiment, start-up controller 110 controls 330 the sound produced by vehicle 105 during start-up operations by controlling at least one of vehicle propulsion system 120 (shown in FIG. 1), exhaust system 140 (shown in FIG. 1), and audio system 145 (shown in FIG. 1). In one implementation, start-up controller 110 causes exhaust system 140 to reposition at least one valve or flap associated with exhaust system 140 to enable one of a quiet start mode and a normal start mode. In another implementation, start-up controller 110 causes engine 125 to operate at different operating speed, i.e., a lower or higher RPM, to enable one of a quiet start mode and a normal start mode. In another implementation, start-up controller 110 enables a quiet start mode by operating vehicle 105 in an electric vehicle mode and enables a normal start mode by operating vehicle 105 in an internal combustion mode. In still another implementation, start-up controller 110 enables a normal start mode by causing audio system 145 to generate a sound during start-up operations and enables a quiet start mode when audio system 145 does not generate a sound.

The methods and systems described herein may be implemented using computer programming or engineering techniques including computer software, firmware, hardware or any combination or subset thereof, wherein the technical effects may be achieved by performing at least one of the following steps: (a) receiving user settings indicative of at least a desired time during which sound generated during start-up operations is controlled; (b) determining current environmental conditions indicative of at least one of a current time of day and a current geographical location of the vehicle; (c) comparing the current environmental conditions with the user settings; and (d) controlling the sound generated by the vehicle during vehicle start-up operations based at least in part on a result of the comparison between the current environmental conditions and the user settings.

Exemplary embodiments of a start-up control system 100 are described above in detail. The methods and systems are not limited to the specific embodiments described herein, but rather, components of systems and/or steps of the method may be utilized independently and separately from other components and/or steps described herein. Each method step and each component may also be used in combination with other method steps and/or components. Although specific features of various embodiments may be shown in some drawings and not in others, this is for convenience only. Any feature of a drawing may be referenced and/or claimed in combination with any feature of any other drawing.

This written description uses examples to describe embodiments of the present disclosure, including the best mode, and also to enable any person skilled in the art to practice the systems and methods described herein, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for controlling start-up operations of a vehicle, said method comprising:
receiving user settings indicative of at least a desired time during which sound generated during start-up operations is controlled;
determining current environmental conditions indicative of at least one of a current time of day and a current geographical location of the vehicle;
comparing the current environmental conditions with the user settings; and
controlling the sound generated by the vehicle during vehicle start-up operations based at least in part on a result of the comparison between the current environmental conditions and the user settings.

2. A method in accordance with claim 1, wherein controlling the sound generated by the vehicle includes controlling a volume of exhaust discharged through an exhaust system of the vehicle.

3. A method in accordance with claim 1, wherein the vehicle is a hybrid electric vehicle, and controlling the sound generated by the vehicle during start-up operations includes starting the vehicle in an electric vehicle mode.

4. A method in accordance with claim 1, wherein receiving user settings includes receiving first user settings associated with a first user and second user settings associated with a second user.

5. A method in accordance with claim 4, wherein said method further comprises one of identifying a first key fob associated with the first user and applying the first user settings during vehicle start-up operations and identifying a second key fob associated with the second user and applying the second user settings during vehicle start-up operations.

6. A method in accordance with claim 1, wherein receiving user settings includes receiving user settings indicative of at least a desired time associated with a geographical area during which the sound generated by the vehicle during start-up operations is controlled.

7. A method in accordance with claim 1, wherein receiving user settings includes receiving user settings from a computing device located remotely from the vehicle.

8. A start-up control system for use in a vehicle, said start-up control system comprising:
a start-up controller configured to:
receive user settings indicative of at least a desired time during which sound generated by the vehicle during start-up operations is controlled;
determine current environmental conditions indicative of at least one of a current time of day and a current geographical location of the vehicle;
compare the current environmental conditions with the user settings; and
control the sound generated by the vehicle during start-up operations based at least in part on a result of the comparison between the current environmental conditions and the user settings.

9. A system in accordance with claim 8, wherein the start-up controller is coupled to an exhaust system, and the start-up controller is further configured to control a volume of exhaust discharged through the exhaust system of the vehicle.

10. A system in accordance with claim 8, wherein the vehicle is a hybrid electric vehicle, and the start-up controller is further configured to start the vehicle in an electric vehicle mode.

11. A system in accordance with claim 8, wherein the start-up sound controller is further configured to receive first user settings associated with a first user and second user settings associated with a second user.

12. A system in accordance with claim 11, wherein the start-up controller is further configured to one of identify a first key fob associated with the first user and apply the first user settings during vehicle start-up operations, and identify a second key fob associated with the second user and apply the second user settings during vehicle start-up operations.

13. A system in accordance with claim 8, wherein the start-up controller is configured to receive user settings indicative of at least a desired time associated with a geographical area during which the sound generated by the vehicle during start-up operations is controlled.

14. A system in accordance with claim 8, wherein the start-up sound controller is further configured to receive user settings from a computing device located remotely from the vehicle.

15. One or more computer readable storage media having computer executable instructions embodied thereon, wherein, when executed by at least one processor, the computer-executable instructions cause the processor to:
receive user settings indicative of at least a desired time during which sound generated by a vehicle during start-up operations is controlled;
determine current environmental conditions indicative of at least one of a current time of day and a current geographical location of the vehicle;
compare the current environmental conditions with the user settings; and
control the sound generated by the vehicle during start-up operations based at least in part on a result of the comparison between the current environmental conditions and the user settings.

16. A computer-readable media in accordance with claim 15, wherein the computer-executable instructions cause the processor to control a volume of exhaust discharged through an exhaust system of the vehicle.

17. A computer-readable media in accordance with claim 15, wherein the vehicle is a hybrid electric vehicle, and the computer-executable instructions cause the processor to start the vehicle in an electric vehicle mode.

18. A computer-readable media in accordance with claim 15, wherein the computer-executable instructions cause the processor to receive first user settings associated with a first user and second user settings associated with a second user.

19. A computer-readable media in accordance with claim 18, wherein the computer-executable instructions cause the processor to one of identify a first key fob associated with the first user and apply the first user settings during vehicle start-up operations, and identify a second key fob associated with the second user and apply the second user settings during vehicle start-up operations.

20. A computer-readable media in accordance with claim 15, wherein the computer-executable instructions cause the processor to store user settings indicating at least a time range associated with a geographical area in which the start-up sound is to be controlled and determine current environmental conditions indicating at least a current time of day and a current geographical area.
